(19) United States
(12) Patent Application Publication
(10) Pub. No.: US 2023/0302344 A1
(43) Pub. Date: Sep. 28, 2023

(54) TECHNOLOGIES FOR INTERACTIVE TRAINING WITH DIGITAL PROJECTION

(71) Applicant: Joshua D. Ruppert, Lakeville, MN (US)

(72) Inventor: Joshua D. Ruppert, Lakeville, MN (US)

(21) Appl. No.: 18/125,945

(22) Filed: Mar. 24, 2023

Related U.S. Application Data
(60) Provisional application No. 63/323,128, filed on Mar. 24, 2022.

(51) Int. Cl. A63B 71/06; A63B 71/02; G06T 13/00

(52) U.S. Cl. CPC A63B 71/0622; A63B 71/03; G06T 13/00; A63B 69/0024

(57) ABSTRACT

Technologies for interactive training include a computing device and a light projection device such as a digital laser projector. The computing device creates a digital practice plan indicative of a play or drill. The play or drill is indicative of multiple player positions. The computing device projects a digital practice plan diagram onto a playing surface with the light projection device. The digital practice plan diagram is based on the digital practice plan and is indicative of the play or drill. The play or drill may be further indicative of movement associated with each player position, and the computing device may animate the digital practice plan diagram on the playing surface based on the digital practice plan. The computing device may receive a user command and further control the animation of the digital practice plan diagram in response to receiving the user command. Other embodiments are described and claimed.

### CROSS-REFERENCE TO RELATED APPLICATION

This application claims the benefit of and priority to U.S. Patent Application No. 63/323,128, entitled “TECHNOLOGIES FOR INTERACTIVE TRAINING WITH DIGITAL PROJECTION,” which was filed on Mar. 24, 2022, and which is incorporated herein by reference in its entirety.

### BACKGROUND

Youth sports training typically involves drills or plays in which a coach instructs players on where to be positioned, where to move, and other aspects of the drill or play. For example, a coach may use physical training accessories such as chalkboards and pylons or cones in order to explain the drills. Additionally, certain indoor facilities such as hockey rinks may be large, noisy, or otherwise make communication between the coach and players difficult. Valuable practice time may be lost while explaining drills or plays.

### SUMMARY

According to one aspect of the disclosure, a computing device for interactive training includes a practice plan manager and a projection manager. The practice plan manager is to create a digital practice plan. The digital practice plan is indicative of a play or drill, and the play or drill is indicative of a plurality of player positions. The projection manager is to project a digital practice plan diagram onto a playing surface with a light projection device. The digital practice plan diagram is based on the digital practice plan and is indicative of the play or drill.

In an embodiment, the projection manager is further to animate the digital practice plan diagram on the playing surface based on the digital practice plan, wherein the play or drill is further indicative of a movement associated with each player position of the plurality of player positions. In an embodiment, the computing device further includes a projection interface to receive a user command in response to animation of the digital practice plan diagram. The projection manager is further to control the animation of the digital practice plan diagram in response to receipt of the user command. In an embodiment, to control the animation comprises to pause, rewind, or step the animation.

In an embodiment, the computing device further includes an editor interface to receive user input indicative of the digital practice plan with an interactive user interface of the computing device. To create the digital practice plan comprises to create the digital practice plan based on the user input.

In an embodiment, the computing device further includes an editor interface to receive user input indicative of an update to the digital practice plan with an interactive user interface of the computing device in response to projection of the digital practice plan diagram. The practice plan manager is to update the digital practice plan based on the user input.

In an embodiment, to project the digital practice plan diagram onto the playing surface with the light projection device comprises to control the light projection device. In an embodiment, to project the digital practice plan diagram onto the playing surface with the light projection device comprises to transmit the digital practice plan diagram to a projector computing device coupled to the light projection device.

In an embodiment, the playing field comprises a hockey rink. In an embodiment, the playing field comprises a basketball court. In an embodiment, the playing field comprises an indoor sports facility.

In an embodiment, the computing device further includes a video manager to display the digital practice plan diagram in conjunction with a video recording of a practice or game. In an embodiment, the computing device further includes an editor interface to receive user input indicative of an update to the digital practice plan with an interactive user interface of the computing device in response to display of the digital practice plan diagram in conjunction with the video recording. The practice plan manager is to update the digital practice plan based on the user input.

According to another aspect, a method for interactive training includes creating, by a computing device, a digital practice plan, wherein the digital practice plan is indicative of a play or drill, and wherein the play or drill is indicative of a plurality of player positions; and projecting, by the computing device, a digital practice plan diagram onto a playing surface with a light projection device, wherein the digital practice plan diagram is based on the digital practice plan and is indicative of the play or drill.

In an embodiment, the method further includes animating, by the computing device, the digital practice plan diagram on the playing surface based on the digital practice plan, wherein the play or drill is further indicative of a movement associated with each player position of the plurality of player positions. In an embodiment, the method further includes receiving, by the computing device, a user command in response to animating the digital practice plan diagram; and controlling, by the computing device, animation of the digital practice plan diagram in response to receiving the user command. In an embodiment, controlling the animation comprises pausing, rewinding, or stepping the animation.

In an embodiment, the method further includes receiving, by the computing device, user input indicative of the digital practice plan with an interactive user interface of the computing device; wherein creating the digital practice plan comprises creating the digital practice plan based on the user input.

In an embodiment, the method further includes receiving, by the computing device, user input indicative of an update to the digital practice plan with an interactive user interface of the computing device in response to projecting the digital practice plan diagram; and updating, by the computing device, the digital practice plan based on the user input.

In an embodiment, projecting the digital practice plan diagram onto the playing surface with the light projection device comprises controlling the light projection device. In an embodiment, projecting the digital practice plan diagram onto the playing surface with the light projection device comprises transmitting the digital practice plan diagram to a projector computing device coupled to the light projection device.

In an embodiment, the playing field comprises a hockey rink. In an embodiment, the playing field comprises a basketball court. In an embodiment, the playing field comprises an indoor sports facility.

In an embodiment, the method further includes displaying, by the computing device, the digital practice plan diagram in conjunction with a video recording of a practice or game. In an embodiment, the method further includes receiving, by the computing device, user input indicative of an update to the digital practice plan with an interactive user interface of the computing device in response to displaying the digital practice plan diagram in conjunction with the video recording; and updating, by the computing device, the digital practice plan based on the user input.

According to another aspect, one or more non-transitory, computer-readable storage media include a plurality of instructions that when executed cause a computing device to perform any of the methods described above.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a schematic diagram illustrating at least one embodiment of a system for interactive training with digital projection;

FIG. 2 is a simplified block diagram of at least one embodiment of the system of FIG. 1;

FIG. 3 is a simplified block diagram of an environment that may be established by a computing device of the system of FIGS. 1-2; and

FIG. 4 is an exemplary flow diagram of at least one embodiment of a method for interactive training that may be executed by the computing device of FIGS. 1-3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors or processing units (e.g., GPUs, or tensor processing units (TPUs)). A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

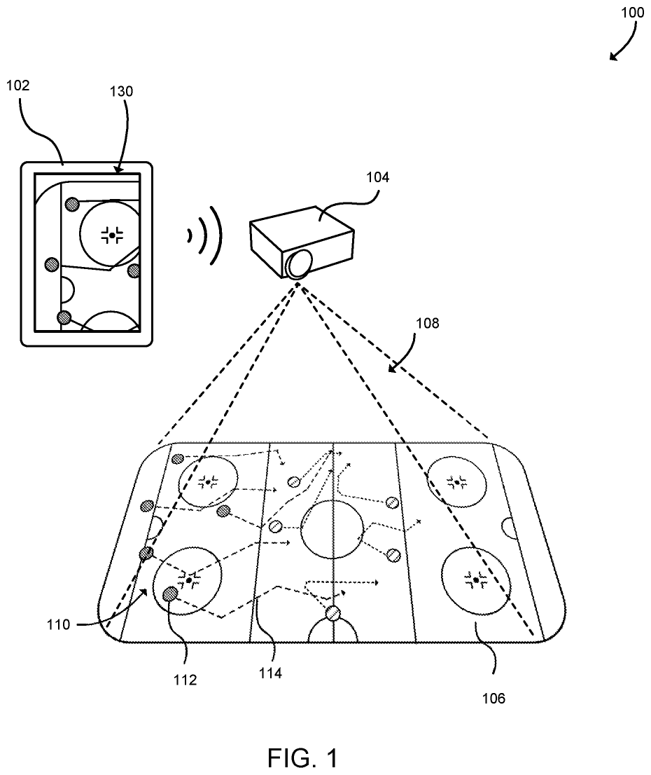

Referring now to FIG. 1, an illustrative system 100 includes a computing device 102 in communication with a light projection device 104 such as a digital projector. In use, as described further below, a coach or other instructor uses the computing device 102 to develop a practice plan for one or more drills, plays, or other training operations for an activity such as youth sports. During a practice session, the computing device 102 causes the light projection device 104 to project diagrams corresponding to the practice plan on to a playing surface 106. As shown, the computing device 102 may provide an interactive user interface that displays the practice plan diagram and may allow editing of the practice plan. Accordingly, the coach may use the computing device 102 to control display with the light projection device 104 and/or to update the practice plan during the practice session.

For example, in the illustrative example shown in FIG. 1, the playing surface 106 is a hockey rink. In other embodiments, the playing surface 106 may be a basketball court, an indoor sports facility, a stage, or other facility. The light projection device 104 is positioned above the surface 106 such that light 108 from the projector may be directed onto the surface 106. The light projection device 104 displays a diagram 110 on the playing surface 106 that is based on the practice plan developed by the coach or other instructor. The illustrative diagram 110 includes symbols 112 indicating player positions and lines 114 indicating movements. In other embodiments, the diagram 110 may be animated (e.g., with the symbols 112 moving as indicated by the lines 114 or otherwise), and may indicate additional symbols or other information. Players may use the projected diagram 110 to assist in performing the drills, plays, or other activities instructed by the coach during ice hockey practice. By using the system 100, practice time may be used more efficiently as compared to traditional physical pylon cones or other tools, which may require manual adjustment and resetting between drills. By using practice time more efficiently, costs may be reduced and/or efficiency may be improved with regard to facility rental fees (e.g., ice time) or other costs associated with youth sports practice. Additionally, by providing visual instruction over the playing surface 106, the system 100 may provide effective instruction for large or noisy environments such as hockey rinks or other indoor sports facilities.

Additionally or alternatively, although illustrated as being used for instruction in youth sports activities such as ice hockey, it should be understood that the system 100 may also be used for instruction in other activities. For example, the system 100 may be used for instruction or training in adult sports, professional sports, or other sports activities. As another example, the system 100 may be used for non-sports activities, such as instruction or training for drill team, theater choreography or blocking, dance choreography, marching band, or other activities.

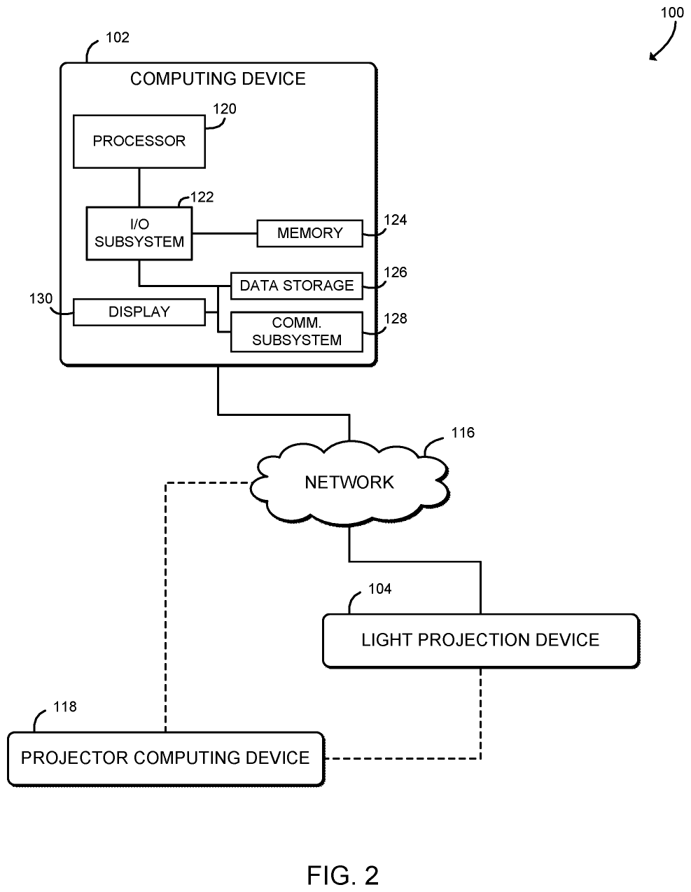

Referring now to FIG. 2, a block diagram of the system 100 is shown. As shown, the computing device 102 is in communication with the light projection device 104 via a network 116. Additionally or alternatively, in some embodiments, the light projection device 104 may be coupled to a projector computing device 118, which interfaces with the network 116. The illustrative computing device 102 may be embodied as any type of device capable of performing the functions described herein. For example, a computing device 102 may be embodied as, without limitation, a tablet computer, a smartphone, a server, a laptop computer, a desktop computer, a consumer electronic device, a rack-mounted server, a blade server, a workstation, a network appliance, a web appliance, a distributed computing system, a multiprocessor system, and/or any other computing device capable of performing the functions described herein. Additionally, although the computing device 102 is illustrated in FIG. 2 as embodied as a single computing device, it should be appreciated that in some embodiments, the computing device 102 may be embodied as multiple devices cooperating together to facilitate the functionality described below. For example, in some embodiments, the computing device 102 may be a client device in communication with a server or a “virtual server” formed from multiple computing devices distributed across the network 116 and operating in a public or private cloud. As shown in FIG. 1, the illustrative computing device 102 includes a processor 120, an I/O subsystem 122, memory 124, a data storage device 126, and a communication subsystem 128. Of course, the computing device 102 may include other or additional components, such as those commonly found in a tablet computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the computing device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication subsystem 128 of the computing device 102 may be embodied as any communication circuit, device, or collection thereof, capable of enabling communications between the computing device 102 and other remote devices. The communication subsystem 128 may be configured to use any one or more communication technology (e.g., wireless or wired communications) and associated protocols (e.g., Ethernet, Bluetooth®, WiMAX, 3G LTE, 5G, etc.) to effect such communication.

As shown in FIG. 1, the computing device 102 includes a display 130. The display 130 may be embodied as any type of display capable of displaying digital images or other information, such as a liquid crystal display (LCD), a light emitting diode (LED), a plasma display, a cathode ray tube (CRT), or other type of display device. As described further below, the display 130 may be used to display and edit digital practice plans. In some embodiments, the display 130 may be coupled to a touch screen to allow user interaction with the computing device 102.

As discussed in more detail below, the computing device 102, the light projection device 104, and/or the projector computing device 118 may be configured to transmit and receive data with each other and/or other devices of the system 100 over the network 116. The network 116 may be embodied as any number of various wired and/or wireless networks. For example, the network 116 may be embodied as, or otherwise include, a wired or wireless local area network (LAN), a wired or wireless wide area network (WAN), a cellular network, and/or a publicly-accessible, global network such as the Internet. As such, the network 116 may include any number of additional devices, such as additional computers, routers, stations, and switches, to facilitate communications among the devices of the system 100.

The light projection device 104 may be embodied as any type of projector, laser, laser pointer, or other controllable light source capable of projecting illuminated digital information onto surfaces and/or objects in the environment (such as the playing surface 106). The light projection device 104 may include components such as a lens, a light source (e.g., one or more laser light sources), and an image creation element such as a liquid crystal display (LCD), a light emitting diode (LED), or other type of display device. Alternatively, the light projection device 104 may include a controllable light source without an image creation element, such as one or more lasers, laser pointers, LEDs, LED arrays, or other light sources. Illustratively, the light projection device 104 may be embodied as a laser projector with a relatively high lumen output suitable for large venues. For example, in some embodiments, the light projection device 104 may have an output of about 2000-3000 lumens. As another example, the projector may have an output of about 6000-7000 lumens. As yet another example, the light projection device 104 may have an output above about 6000 lumens. Of course, in other embodiments, any appropriate projector may be used. Additionally, although illustrated as a single light projection device 104, in some embodiments the system 100 may use multiple projectors 104, for example to cover the entire playing surface 106.

The computing device 102 may communicate image data directly to the light projection device 104 for display, for example using one or more wireless communication technologies. The computing device 102 and the light projection device 104 may communicate directly (e.g., using a peer-to-peer wireless protocol such as Wi-Fi Direct) or via the network 116. In some embodiments, the computing device 102 may communicate image data to the projector computing device 118 for display by the light projection device 104. The projector computing device 118 may be coupled to the light projection device 104 directly (e.g., through HDMI or another display output) or via the network 116. The projector computing device 118.

The projector computing device 118 may be embodied as any type of computation or computer device capable of performing the functions described herein, including, without limitation, a computer, a workstation, a set-top box, a digital media player device, a laptop computer, a notebook computer, a tablet computer, a mobile computing device, a server, a rack-mounted server, a blade server, a wearable computing device, a multiprocessor system, a network appliance, a web appliance, a distributed computing system, a processor-based system, and/or a consumer electronic device. Thus, the projector computing device 118 includes components and devices commonly found in a computer or similar computing device, such as a processor, an I/O subsystem, a memory, a data storage device, and/or communication circuitry. Those individual components of the projector computing device 118 may be similar to the corresponding components of the computing device 102, the description of which is applicable to the corresponding components of the projector computing device 118 and is not repeated herein so as not to obscure the present disclosure.

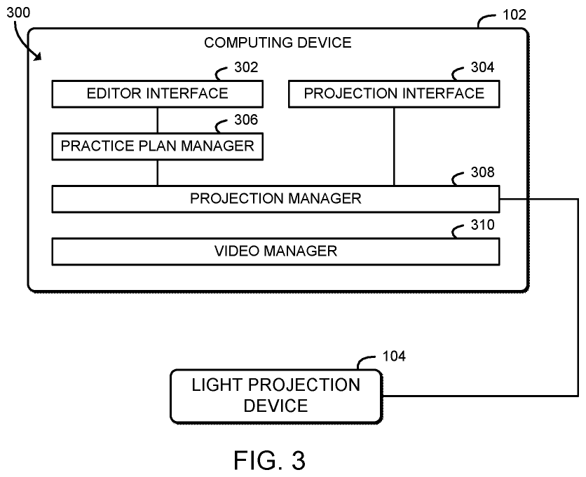

Referring now to FIG. 3, in the illustrative embodiment, the computing device 102 establishes an environment 300 during operation. The illustrative environment 200 includes a editor interface 302, a projection interface 304, a practice plan manager 306, a projection manager 308, and, in some embodiments, a video manager 310. The various components of the environment 300 may be embodied as hardware, firmware, software, or a combination thereof. As such, in some embodiments, one or more of the components of the environment 300 may be embodied as circuitry or a collection of electrical devices (e.g., editor interface circuitry 302, projection interface circuitry 304, practice plan manager circuitry 306, projection manager circuitry 308, and/or video manager circuitry 310). It should be appreciated that, in such embodiments, one or more of those components may form a portion of the processor 120, the I/O subsystem 122, and/or other components of the computing device 102.

The editor interface 302 is configured to receive user input indicative of a digital practice plan with an interactive user interface of the computing device 102. The editor interface 302 may receive the user input before projecting a digital practice plan diagram, in response to projecting the digital practice plan diagram.

The projection interface 304 is configured to receive a user command in response to animating the digital practice plan diagram as described below. The user command may, for example, request to pause, rewind, or step the animation.

The practice plan manager 306 is configured to create the digital practice plan. The digital practice plan is indicative of a play or drill. The play or drill is indicative of multiple player positions. In some embodiments, the play or drill is further indicative of a movement associated with each player position. The digital practice plan may be created based on user input or updated based on user input.

The projection manager 308 is configured to project a digital practice plan diagram onto a playing surface 106 with the light projection device 104. The digital practice plan diagram is based on the digital practice plan and is indicative of the play or drill. Projecting the digital practice plan diagram may include controlling the light projection device 104 or transmitting the digital practice plan diagram to the projector computing device 118 coupled to the light projection device 104. In some embodiments, the projection manager 308 is further configured to animate the digital practice plan diagram on the playing surface 106 based on the digital practice plan. The projection manager 308 may be further configured to control the animation of the digital practice plan diagram in response receiving a user command. Controlling the animation may include pausing, rewinding, or stepping the animation.

The video manager 310 is configured to display the digital practice plan diagram in conjunction with a video recording of a practice or game. The editor interface 302 may also be configured to receive user input in response to displaying the digital practice plan diagram in conjunction with the video recording.

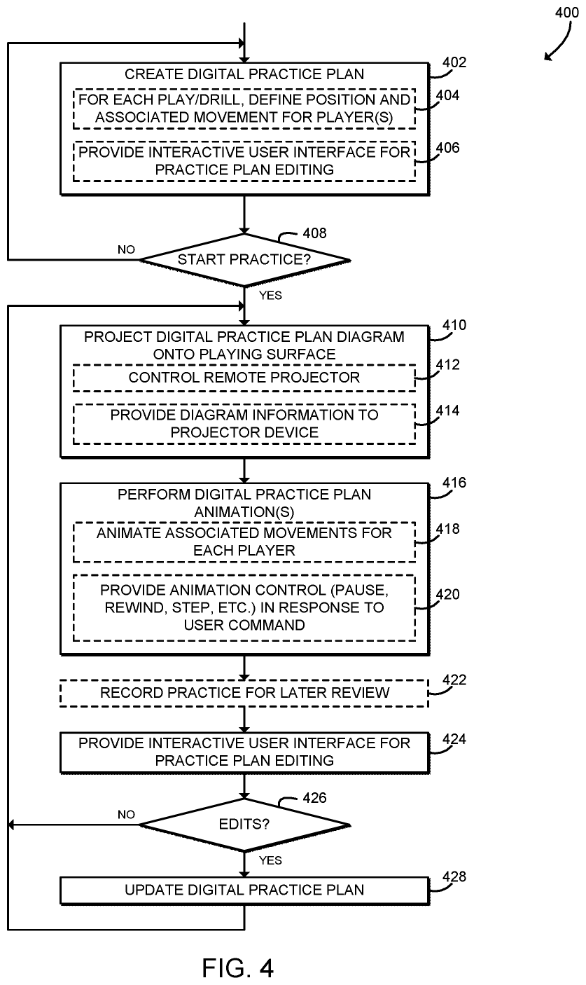

Referring now to FIG. 4, in use, the computing device 102 may execute a method 400 for interactive training. It should be appreciated that, in some embodiments, the operations of the method 400 may be performed by one or more components of the environment 300 of the computing device 102 as shown in FIG. 3. The method 400 begins with block 402, in which the computing device 102 creates a digital practice plan. The digital practice plan describes a play, a drill, or other activity that may be performed during a training session. The digital practice plan may include symbols or other indicators for multiple players or other participants in the training session. In some embodiments, in block 404 the computing device 102 may define a position and associated movement for one or more players for each play or drill. The position may be defined, for example, with respect to markings or other landmarks on the playing surface 106. The movement may be defined as a line, an arrow, a trajectory, or other indication of movement, and may define a starting position, an ending position, one or more intermediate positions, or other attributes of the movement. In some embodiments, in block 406 the computing device 102 may provide an interactive user interface for editing the digital practice plan. For example, the computing device 102 may use a touchscreen display 130 or other user interface to allow a coach or other user to manipulate the digital practice plan. The coach may, for example, add or remove indicators for players, change symbols (e.g., X's and O's) or colors for the players, add labels for position, type, or other name of each player (e.g., center, wing, defense, goaltender, or associated abbreviation), adjust movement patterns, or otherwise edit the digital practice plan. The computing device 102 may also provide a user interface to perform tasks such as saving a particular play or drill, creating a new play or drill, arranging an order of plays or drills, or otherwise managing the digital practice plan.

In block 408, the computing device 102 determines whether to start a practice session. The practice session may be started, for example, in response to a user command received from the coach or other user of the computing device 102. If the computing device 102 determines not to start the practice session, the method 400 loops back to block 402, in which the digital practice plan may be edited or otherwise updated. If the computing device 102 determines to start the practice session, the method 400 advances to block 410.

In block 410, the computing device 102 projects a digital practice plan diagram based on the digital practice plan onto the playing surface 106. The digital practice plan diagram may be based on a particular play or drill included in the digital practice plan, and may include symbols or other indications of positions for multiple players or other participants in the training activity. As described above, the digital practice plan diagram is projected by the light projection device 104 onto the playing surface 106. In some embodiments, the light projection device 104 may be preinstalled or otherwise configured to illuminate the playing surface 106. When the digital practice plan diagram is projected onto the playing surface 106, the digital practice plan diagram is visible to the players or other participants in the practice session. The computing device 102 may use any appropriate technique to project the digital practice plan diagram with the light projection device 104. In some embodiments, in block 412 the computing device 102 may directly control the remote light projection device 104. In some embodiments, in block 414, the computing device 102 may provide digital practice plan diagram information to the projector computing device 118 for display.

In block 416, the computing device 102 may perform digital practice plan animations with the light projection device 104. In some embodiments, in block 418 the computing device 102 may animate a movement associated with one or more of the players. For example, the computing device 102 may cause the light projection device 104 to move the symbol associated with a player from a particular starting position to an ending position, along a trajectory, or otherwise animate the symbol. The computing device 102 may also cause the light projection device 104 to project a line or other indication of the whole movement. The computing device 102 may perform the animation once, may loop the animation, or may otherwise control playback of the animation. In some embodiments, in block 420 the computing device 102 may provide animation control in response to a user command, which may be received with a touchscreen display 130 or other user interface. For example, the computing device 102 may pause, rewind, step through, advance in slow motion, or otherwise control the projected animation.

In some embodiments, in block 422 the computing device 102 may record a practice session or game for later review. The practice session may be recorded, for example, by a video camera or other camera device coupled to the computing device 102. In some embodiments, the practice session may be recorded by a separate video camera or other video recorder. In those embodiments, the computing device 102 may access a video file or other data indicative of the practice session at a later time. For later review, the computing device 102 may display the practice plan in conjunction with the practice session, for example as an overlay over a video of the practice session. During this video review, the practice plan may also be animated and controlled as described above.

In block 424, during the practice session, the computing device 102 may provide an interactive user interface for practice plan editing. The user interface may be similar to or the same as the interface used to create the digital practice plan prior to the practice session. For example, the computing device 102 may use a touchscreen display 130 or other user interface to allow a coach or other user to manipulate the digital practice plan. The coach may, for example, add or remove indicators for players, change symbols (e.g., X's and O's) or colors for the players, adjust movement patterns, or otherwise edit the digital practice plan. The computing device 102 may also provide a user interface to perform tasks such as saving a particular play or drill, creating a new play or drill, arranging an order of plays or drills, or otherwise managing the digital practice plan.

In block 426, the computing device 102 determines whether the digital practice plan was edited. If not, the method 400 loops back to block 410, in which the computing device 102 continues to project and/or animate the digital practice plan diagram using the light projection device 104. Referring back to block 426, if the computing device 102 determines that the digital practice plan was edited, the method 400 advances to block 428. In block 428, the computing device 102 updates the digital practice plan, for example by saving or otherwise committing the edits performed by the coach or other user. After updating the digital practice plan, the method 400 loops back to block 410, in which the computing device 102 projects the updated diagram using the light projection device 104.

1. A computing device for interactive training, the computing device comprising:
a practice plan manager to create a digital practice plan, wherein the digital practice plan is indicative of a play or drill, and wherein the play or drill is indicative of a plurality of player positions; and
a projection manager to project a digital practice plan diagram onto a playing surface with a light projection device, wherein the digital practice plan diagram is based on the digital practice plan and is indicative of the play or drill.

2. The computing device of claim 1, wherein the projection manager is further to animate the digital practice plan diagram on the playing surface based on the digital practice plan, wherein the play or drill is further indicative of a movement associated with each player position of the plurality of player positions.

3. The computing device of claim 2, further comprising:
a projection interface to receive a user command in response to animation of the digital practice plan diagram;
wherein the projection manager is further to control the animation of the digital practice plan diagram in response to receipt of the user command.

4. The computing device of claim 3, wherein to control the animation comprises to pause, rewind, or step the animation.

5. The computing device of claim 1, further comprising:
an editor interface to receive user input indicative of the digital practice plan with an interactive user interface of the computing device;
wherein to create the digital practice plan comprises to create the digital practice plan based on the user input.

6. The computing device of claim 1, further comprising:
an editor interface to receive user input indicative of an update to the digital practice plan with an interactive user interface of the computing device in response to projection of the digital practice plan diagram;
wherein the practice plan manager is to update the digital practice plan based on the user input.

7. The computing device of claim 1, wherein to project the digital practice plan diagram onto the playing surface with the light projection device comprises to control the light projection device.

8. The computing device of claim 1, wherein to project the digital practice plan diagram onto the playing surface with the light projection device comprises to transmit the digital practice plan diagram to a projector computing device coupled to the light projection device.

9. The computing device of claim 1, wherein the playing field comprises a hockey rink or a basketball court.

10. The computing device of claim 1, wherein the playing field comprises an indoor sports facility.

11. The computing device of claim 1, wherein the light projection device comprises a laser light source.

12. The computing device of claim 1, further comprising a video manager to display the digital practice plan diagram in conjunction with a video recording of a practice or game.

13. The computing device of claim 12, further comprising:
an editor interface to receive user input indicative of an update to the digital practice plan with an interactive user interface of the computing device in response to display of the digital practice plan diagram in conjunction with the video recording;
wherein the practice plan manager is to update the digital practice plan based on the user input.

14. A method for interactive training, the method comprising:
creating, by a computing device, a digital practice plan, wherein the digital practice plan is indicative of a play or drill, and wherein the play or drill is indicative of a plurality of player positions; and
projecting, by the computing device, a digital practice plan diagram onto a playing surface with a light projection device, wherein the digital practice plan diagram is based on the digital practice plan and is indicative of the play or drill.

15. The method of claim 14, further comprising animating, by the computing device, the digital practice plan diagram on the playing surface based on the digital practice plan, wherein the play or drill is further indicative of a movement associated with each player position of the plurality of player positions.

16. The method of claim 15, further comprising:
receiving, by the computing device, a user command in response to animating the digital practice plan diagram; and
controlling, by the computing device, animation of the digital practice plan diagram in response to receiving the user command.

17. The method of claim 16, wherein controlling the animation comprises pausing, rewinding, or stepping the animation.

18. The method of claim 14, further comprising:
receiving, by the computing device, user input indicative of the digital practice plan with an interactive user interface of the computing device;
wherein creating the digital practice plan comprises creating the digital practice plan based on the user input.

19. The method of claim 14, further comprising:
receiving, by the computing device, user input indicative of an update to the digital practice plan with an interactive user interface of the computing device in response to projecting the digital practice plan diagram; and
updating, by the computing device, the digital practice plan based on the user input.

20. The method of claim 14, wherein projecting the digital practice plan diagram onto the playing surface with the light projection device comprises controlling the light projection device.
